(19) United States
(12) Patent Application Publication
(10) Pub. No.: US 2008/0091659 A1
(43) Pub. Date: Apr. 17, 2008

(54) SYSTEM AND METHOD FOR CONSUMPTION AND UTILIZATION ANALYSIS IN AN ORGANIZATION

(76) Inventor: WILLIAM J. McFAUL, JACKSON, NJ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/870,843

(22) Filed: Oct. 11, 2007

Related U.S. Application Data
(60) Provisional application No. 60/829,386, filed on Oct. 13, 2006.

(51) Int. Cl. G06F 17/30; G06F 17/40; G06Q 10/00

(52) U.S. Cl. 707/3; 705/7; 707/E17.014

(57) ABSTRACT

A method and system for analyzing consumption an utilization patterns of organizations. The usage of materials and the behavior of people is tracked in an organization. These factors are analyzed and used in order to reduce the costs associated with usage of materials and services.

This application claims the benefit of U.S. Provisional Application No. 60/829,386, filed Oct. 13, 2006, the entirety of which is hereby incorporated by reference.

### 1. FIELD OF THE INVENTION

This invention relates to a system and method for reducing costs in an organization. In particular the system and method relates to the detailed analysis of the use of materials and services purchased and consumed in various organizations.

### 2. BACKGROUND OF THE INVENTION

Large organizations use a variety of materials and services. The types and volumes of materials and services used greatly affects the overall cost of running the organization. This can be especially true in hospitals where large numbers of products are frequently disposed of and replaced, as well as the ongoing consumption of pharmaceuticals. The behavior of personnel who utilize and consume these materials and services as well as the treatment of patients also greatly affects the overall costs of running the organization.

For example, savings may be obtained from simply switching from disposable to reusable supplies. However, it may turn out that some supplies actually cost more to reuse, via sterilization and associated collateral costs. By tracking and accounting for a variety of different products and services that can affect the costs of running an organization tremendous amounts of money can be saved by detecting those items whose change in use or through replacement purchases can greatly affect the overall costs.

Therefore there is a need in the field for an improved method and system of tracking and analyzing the usage of materials and services in organizations.

### SUMMARY OF THE INVENTION

It is therefore an object of the invention to provide an improved method and system of tracking and analyzing the usage of materials and services in organizations.

A first aspect of the invention may be a method of reducing costs in a system comprising the steps of: tracking material and/or services used by an organization by generating data about said material and/or services; sending the data to a database; providing the data to a server from the database processing the data at the server in order to analyze usage of said materials and/or services; and transmitting the results of processing the data to a client.

A second aspect of the invention may be a system for tracking comprising: a client for querying a server for data related to at least one of the categories selected from the group consisting of material, people and services; a server for receiving queries from said client related to said at least one of the categories; a database for receiving data, wherein said database stores data related to said at least one of the categories; and wherein said server is further enabled to analyze said data in order to track the usage of the said categories.

A third aspect of the invention may be a method of reducing costs in a system comprising the steps of: gathering past data related to material and/or services used by an organization by accessing data about said material and/or services accumulated by the organization; providing the data to a server; processing the data at the server in order to analyze usage of said materials and/or services; and transmitting the results of processing the data to a client; wherein the result comprise improvements to existing usage of materials and/or services.

A fourth aspect of the invention may be a method of using comparison metrics in a healthcare organization comprising: analyzing data kept by a healthcare organization; establishing a first metric related to usage of material and/or services; establishing a second metric related to usage of material and/or services; establishing a third metric establishing a time frame; combining said first metric, said second metric and said third metric in order to create a comparison unit; using said comparison unit to compare said healthcare organization with other healthcare organizations; providing means for improving said healthcare organization

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram of the system employed in tracking materials and people data, according to an embodiment of the invention.

FIG. 2 is a flow chart illustrating the process used in order to access information regarding material and people data, according to an embodiment of the invention.

FIG. 3 is a flow chart that illustrates the process used in order to automatically reorder supplies, according to an embodiment of the present invention.

FIG. 4 shows a sample data item that is used in the system, according to an embodiment of the present invention.

### DETAILED DESCRIPTION OF THE INVENTION

In the running of large organizations various factors may affect the ultimate costs associated with the operation. These factors may be altered in order to minimize costs and streamline the operation of the organization. However, the factors that need to be altered need to be identified. The process of identifying those processes that may require change, may involve the tracking of materials and services that are associated with the operation of the organization, as well as the identification and retrieval of information already contained within the organization.

In procuring data related to usage analysis it is important to keep track of a number of factors that can play into tracking material and service usage, it is contemplated that the term “usage” encompasses any usage including consumption of materials and equipment as well as well as any receipt, employment, and/or performance of services. Some of these factors may be what is used, how it is used, how much of it is used, who used it, and where and when it was used. Other information that may be kept track of is the correlation of the usage of a material's and/or service with that of another, and how the usage of one is affecting the usage of another. The presence of a certain types of customers, or certain patients may also affect the usage of materials and services. An employee's usage of different materials and services may also be tracked. This can result in the discovery of waste and potential misuse of materials and services by employees of an organization.

The usage of material and services may be compared to previous usage by people and to the usage of the material by similar types of organizations. For example, a hospital can compare the pounds of linen they processed against that of other facilities while accounting for the various differences between the two organizations. The numbers may be adjusted based upon each organization's complexity level and their respective patient load, or normalized to a standard established by a network of the organizations. Using this data, a hospital could reduce the overall annual expenditures per an occupied hospital bed without being forced to reduce their purchase prices or quality of service. At the same time, by merely instituting linen change policies prepared by nursing personnel, considerable time could be saved by nurses, thereby further increasing the quality of care.

Category comparisons can also be made between the used materials themselves. For example the usage of latex free gloves as a percentage of all gloves used may be analyzed. Other objects of analysis may be the usage of I.V. administration sets with filters as a percentage of all sets, the ratio of first, second and third generation cephalosporin antibiotics. The ratio of streptokinase versus tissue plasminogen activator (tPA) or a comparison of one type of laboratory test to another—all based on any applicable consumption metrics (e.g., patient days, admissions, etc.). The ratio of reusable products used in contrast to disposables (e.g. surgeons gowns or isolation gowns); and consumption of the number of underpads for beds as sorted by various sizes (e.g. 17½″×24″, 23″×24″, 24″×36″, etc.). This analysis may be performed based upon a selected time frame such as an adjusted patient day. Various procedures may be analyzed in view of material usage, such as the number of surgeons gloves used when adjusted for procedure type or the various types of implantables such as stents, pacemakers, hips, etc. may also be monitored. Additionally, the usage of specific materials and/or services, including various inventory items, may be analyzed in order to keep track of trends in order to determine if the trend is an anomaly or indicative of some other problem.

In the examples provided above measurement metrics units for hospitals can be determined by any standard hospital measure such as patient days, admission time, surgical procedure, ER/ED visits, clinic visits, full time equivalent employee (FTE) hours or days, etc. Hybrid measurements may also be used, such as combining the previously mentioned units in order to obtain specific types of information in order to compare and adjust the information received. Standard metric units may also be developed and used for different types of organizations as well, and can encompass concepts such as products manufactured/per day, services rendered per/day, etc.

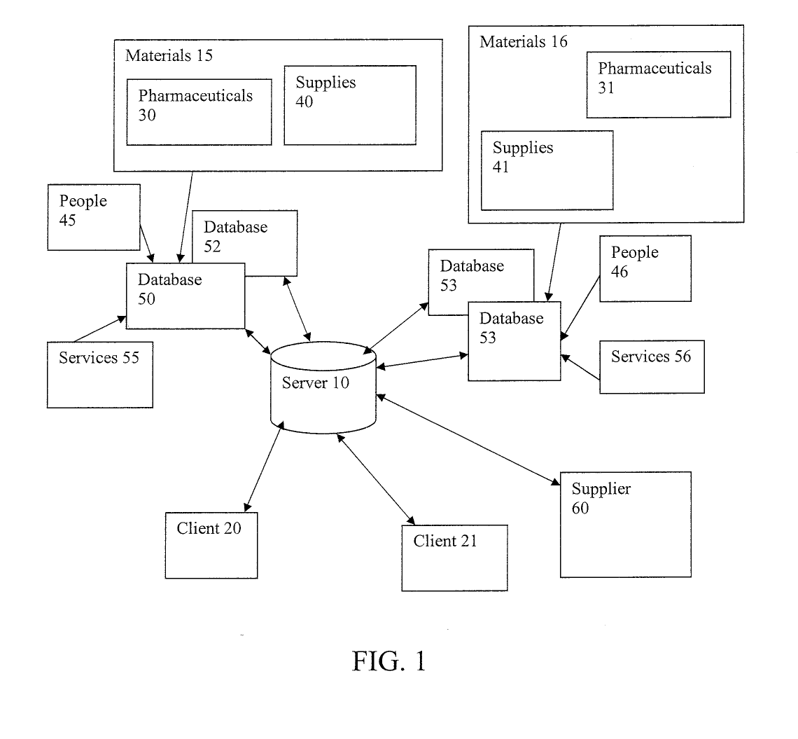

FIG. 1 is a diagram that illustrates the various components that may exist in a system that performs usage analysis in accordance with an embodiment of the invention. The system shown in FIG. 1 is employed in a hospital network. The clients 20 and 21 may be hospitals, part of a hospital network, or some other organization that may benefit from the analysis of its daily operations, as well as the comparisons that may be made between it and the operations of similar organizations.

In the system shown in FIG. 1, it is contemplated that the data that is tracked and analyzed is stored locally but processed at a location central to those who are members of a network. However it should be understood that the step of analyzing may occur in localized areas and may simply involve one hospital or organization that is accessing all of the information internally and performing all subsequent analysis internally.

The clients 20, 21 shown in FIG. 1 are adapted for accessing the server 10. The clients 20, 21 may be computer systems that have the ability to access the server 10 over the internet, or some other type of Wide Area Network (WAN) or Local Area Network (LAN). The clients 20, 21 are enabled to retrieve and view information delivered to them from the server 10. More than one client can be located at a particular location or for a particular organization. It should also be understood that it is possible to have more clients than that shown in FIG. 1.

The server 10 is made up of a processor or group of processors that are capable of relaying information to the clients 20, 21 when a request is made or when the time of a pre-scheduled event has occurred in those scenarios involving an automated transmission of information. The server 10 may perform the roles of an application server, web server, and/or database server. It is also anticipated that the server 10 is load balanced in order to prevent the system from becoming overburdened. The server 10 has loaded thereon a series of programs that can analyze the information that it receives from the databases 50, 51. It is contemplated that in some embodiments, once the information is analyzed that the server 10 may automatically order any necessary materials 15 from a supplier 60, or institute changes in the way services 55 are rendered, or in the way the materials 15,16 are purchased. It is also possible that the server 10 may utilize historical data in order to anticipate a potential shortfall of certain supplies 40, 41, or pharmaceuticals 30, 31 and subsequently order the necessary materials 15, 16 from the supplier 60.

The server 10 is enabled to receive and transmit data to different entities. In particular it is adapted to receive data from the databases 50, 51 which compile the information from each location regarding the materials 15, 16, the people data 45, 46 and the services 55, 56 that are being rendered. Data may be received and/or transmitted via hard connections such as cable and the internet; wireless connections, and/or manually entered. The data may be also stored for an indefinite period of time at the server 10, as well as at the databases 50 and 51 for quick and easy access by a clients 20 and 21. The server 10 may also have information related to pricing as well as lists of distributors for various types of material 15 so as to provide rapid cost analysis for the clients 20, 21. This pricing information may be periodically updated in order to keep the information current. The server 10 may also have standard information related to various services and procedures. Typical and/or historical consumption and/or usage of materials 15 may be stored, as well as typical and/or historical consumption and/or usage of services 55.

The databases 50 and 51 store information that is received from the materials 15, 16 and the people data 45, 46. The databases 50 and 51 may comprise a series of data storage components, such as hard disks, magnetic disks, optical disks, etc. and other standard data storage devices. The databases 50 and 51 may store information for an indefinite period of time. The data stored on the databases 50 and 51 may either be queried by the server 10 at different times, or alternatively be uploaded to the server 10 at pre-scheduled times. The databases 50 and 51 may only store the data for a predetermined time before transmitting the information to the back-up databases 52, 53.

The back-up databases 52, 53 are for storing information for longer periods of time and for acting as substitute databases in the event that the databases 50 and 51 become inoperable. The back-up databases 52 and 53 are also adapted for transferring information directly to the server 10.

The databases 50, 51 are adapted to receive data from different sources. Data may be received from the materials 15, 16, as well as from the various people 45, 46. The materials 15, 16 may include items such as pharmaceuticals 30, 31 and supplies 40, 41. The materials 15, 16 may be tracked using a variety of devices such as radio frequency identification devices (RFIDs), barcodes, and/or manually entered information, or information that has been previously stored or tracked may be used in order to perform the analysis.

An example of tracking information involving RFID tags is now discussed. An item of the material 15 may have a RFID tag attached to it. RF transmitters and receivers may be located at various locations throughout the organization. The tag is used for registering the removal and/or use of the item within a network, a series of various metrics may be developed and used based upon the data that is to be tagged. For example, in an organization such as a store, removal of the item of material 15, such as a product (A) may be correlated and compared to a comparison unit, such as number of customers (B), visiting a store in a set period (C), or a particular section of the store, such as an aisle. The set period (C) may be initiated by scanning the REID tags of the units within the targeted section at the beginning and end of the pre-determined comparison period. This information may then be taken in order to determine purchase volume per customers per a set period of time (D), which would be the number of product (A) divided by the number of customers (B) for a set period of time (C). Adjustments may be made to displays and other visual merchandising variables which may be in use at locations with higher sales per unit of traffic.

As an alternative to using RFID tags, a barcode associated with the material 15 item may be scanned when removed and/or used. A person may have a card that they carry that additionally has a bar code on it that is scanned when taking or removing an item from the material 15. It is also possible to simply track when a container is empty or an entire package is gone and manually enter this information into the database 50.

It is to be understood that tracking and recording technology may be preexisting at an organization. Organization's that already have in place systems that receive and store a variety information may employ the instant invention. In these instances the system and method for consumption and usage analysis may be retrofitted onto the pre-existing system in order to incorporate existing infrastructure in performing the analysis. Previously existing data may also be taken and analyzed and cross-correlated with data from other organizations or incorporated into new ways of analyzing the data.

It is also possible to correlate the individual use of materials 15, 16 so that it can be tracked and correlated with data from the people 45, 46 who use the items. The number of times an item is used, as well as those devices that might be associated with the usage may be tracked. By tracking the people 45 who use the material 15 it can be ascertained if certain individuals have misappropriated items, or if one individual is using a certain item more than others. This information can be then be used to adjust personnel and procedures. Furthermore, it is contemplated that RFID tags can be used to analyze the usage of reusable items in order to determine the useful life of a material 15 item. It is contemplated that this information can be used to analyze the life span and number of times that an item of material 15 can be reprocessed at a certain organization (for example the usage of sterile items).

It may also be possible to keep and track information related to the completion of services 55, 56 and/or the duration of certain services. This may be tracked by manually indicating when a service is achieved, or by correlating some necessary piece of equipment with movement through a certain area. For instance tracking the movement of a food cart through a hospital may provide an indication as to when patients are being fed. Tracking of a floor waxing machines through hospital may indicate when floors are cleaned. This data may be used in conjunction with other types of data in order to develop metrics regarding productivity as cost saving measures.

It may be possible in a hospital setting that the data accumulated can be used for specific analytical tasks, such as the tracking and analysis of data related to the pharmaceuticals 30, 31. In these instances it may be possible to adjust the ordering of certain pharmaceuticals based upon usage. For instance, it may be determined that certain antibiotics are used that may be easily replaced with less costly alternatives. The amount of supplies that are maintained in stock can also be fine tuned based upon usage over certain periods of time.

Tracking of pharmaceuticals 30, 31 can also be used in conjunction with the tracking of certain people 45, 46, such as personnel and/or patients in order to determine if certain physicians frequently overuse certain pharmaceuticals or typically use pharmaceuticals that may be readily replaced by generics. It may also be determined if certain personnel are misusing the stock in other ways. It can also be used in analyzing the administration of pharmaceuticals 30, 31 to patients. This information can be further used in order to enhance the security measures or to provide educational measures that would provide information to personnel regarding alternatives to the usage of different types of pharmaceuticals. Surgical procedures could also be analyzed in order to determine what cost saving measures could be employed in these different scenarios.

It may also be possible to keep track of the admitted patients in hospitals. The number of patients admitted and their stay time could be analyzed in order to make decisions regarding those materials 15 that are used in order to maintain their upkeep, such as the type of food and the manner of use of disposable versus reusable items. These various categories could be analyzed in order to determine which procedures regarding product or service selection or utilization need to be adjusted in order to reduce overall costs.

Included in the materials 15 may also be items of major equipment. For instance, in a hospital setting the usage of portable diagnostic equipment can be analyzed such as EKG machines and portable x-ray machines in order to determine the frequency of use and actual required need for the equipment. Non-diagnostic equipment can be analyzed as well, such as the usage of wheelchairs, stretchers, soda machines, floor waxing machines, etc. Also the removing of linens and other easily transportable items may be kept track of through the usage of alarms or other monitoring systems placed at entrances and exits throughout the organization. These types of tracking may be accomplished via the usage of RFID tags or similar tracking mechanisms, registering of usage or through other various means for tracking the usage.

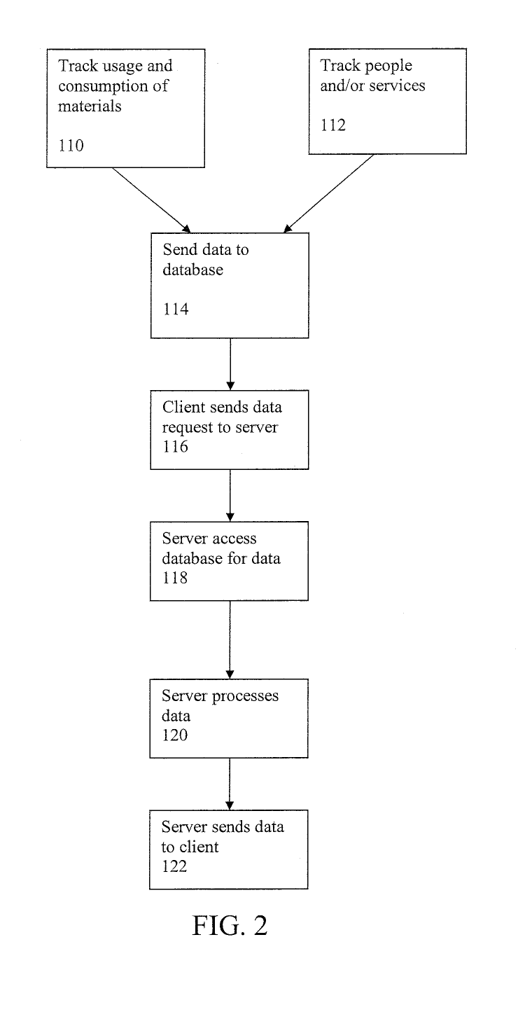

FIG. 2 is a flow chart that illustrates the method used in tracking usage and supplying the data to a client 20. The method will be discussed in reference to one member of the network. At step 110, the usage of the material 15 is tracked, at step 112 people 45 and/or services 55 are tracked. The tracking at step 110 may be accomplished by a variety of means, such as by sensors, via manual entry of the data, or through the scanning of the information using barcodes. People and services are tracked in step 112 either by using sensors, or by entering information regarding the person's usage of various materials, equipment, pharmaceuticals, etc. All three categories may be tracked and cross-correlated with each other.

It is also contemplated that preexisting data may be taken from organizations and employed in the analysis. This involves taking the preexisting information and either downloading it to a database and/or transmitting it to a server. The preexisting information may either be transmitted directly through the computer equipment or entered manually. This information may then be analyzed by being placed into the metric units that are being used in the comparisons that are occurring within the network and then compared to the other organizations in the network.

At step 114 the tracked information data may be sent to the databases 50. The data may then be transmitted either wirelessly or via a hard-line connection to the databases 50. The database 50 then stores the information for a predetermined amount of time.

At step 116, the client 20 sends a request to the server 10. This request may be any number of inquiries related to the materials 15, the services 55 and/or the people 45, and/or a combination of information related to the materials 15, the services 55 and the people 45. For instance, a request for the amount of disposable gloves used per a patient may be queried. Should the client 20 belong to a network, this query, in this example, may further query the usage of gloves in other hospitals in the network. This query may be structured in such a way that factors such as procedure type and personnel who use the gloves may also be queried.

At step 118, after the server 10 receives the data request from the client 20, the database 50 is accessed. The server 10 will access the relevant data from the database 50 and if the request is for information from multiple hospitals and/or organizations, then additional databases, such as the database 51 will be accessed. It is further possible that standard indexed information may accessed from public or private servers, such as pricing charts for certain items, and other relevant information.

At step 120, the server 10 will process the data that it receives from the database 50 and/or the database 51. In order to process the data an analytical program may be run in order to facilitate the processing of the information. The analytical program may be tailored specifically to analyze the requested data.

At step 120, the server 10 will in particular take the data received and place it into categories and will create comparison data, by establishing various metrics against which the data received can be compared to other organizations within the network in order to achieve a more complete picture of usage. The comparison metrics created may be taken from information sources that are part of the tracked information. Comparison metrics may include but is not limited to information such as the number of full time equivalent employees, the total number of employee payroll hours, the number of visitors or guests, the number of patients in the hospital, the number of surgical procedures, the numbers of specific procedures, the number of Medicare patient admissions or their total in-patient days, the number of ER/ED visits, the total number of days patient remained in the hospital, the number of days certain types of patients were being treated in the hospital. The data pertaining to these comparisons may be kept at the database 50, or at the server 10, while the server 10 will be capable of using the metrics in order to perform the data comparisons.

The comparison metrics may be organized in order to be synchronized with the input of the usage of materials and/or services. This may be done in order to assess the numbers of units consumed in comparison to the metrics units for a similar time frame. For example, an organization could analyze the consumption of soft drinks as compared to inpatient days in a hospital. In doing this the tracked data for the material 15 would be the volume of soft drinks, which would be the first metric A, the second metric would be the number of inpatient days B. The inpatient days may also be a piece of data that is being tracked in the system through the usage of data about the people 45, whether manually entered or obtained through other methods. This information can be analyzed for a third metric, which may be a certain time frame C, such as inpatient days for a week, or weekend. This may then result in providing the volume of soft drinks units consumed during the period being analyzed. This data can then be compared to the data from other organizations in order to determine the norms. Then, if for example it was desired that more soft drinks be consumed, other metric data may be examined for the organizations, such as location of soft drink machines. The information may then be used in order to improve the overall usage of the soft drinks.

Other examples where the usage of these metrics may be provided would be in the provision of food in the health care network and also in order to anticipate the need of certain materials related to the care of patients. The numbers of anticipated meals to be served and the amount of meat or seafood required per serving could be determined and supplies could be according kept. This could then be compared to other metrics, such as the total volume of bulk meat purchased. It is also possible to anticipate and calculate the number of admission kits used, etc. Furthermore, metrics related to pharmaceuticals may be used, such as doses provided, dose per patient, dose related to patient days, etc. based on metrics relative to types of procedures or diagnosis.

At step 122, the server 10 will send the requested data to the client 20. The data sent to the client 20 may be raw data that has been accumulated and requested from the database 50, or alternatively it may be the processed data that has been analyzed in some manner, such as those ways discussed above. The data may be sent to the client 20 in a predefined format in order to facilitate ease of access and interpretation.

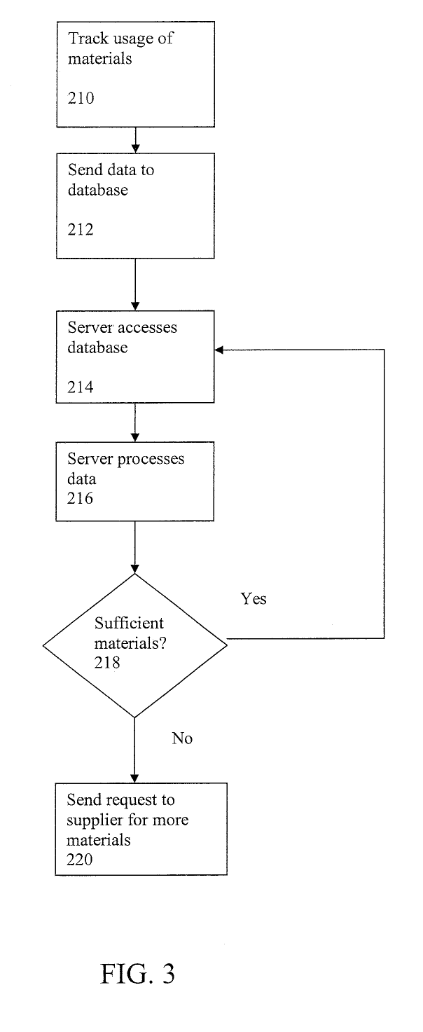

FIG. 3 is a flow chart that illustrates a process that may be used in some embodiments of the instant invention. This process may be used in order to automatically reorder materials 15 or to automatically adjust and/or alter services 55. At step 210 the usage of the materials 15 may be tracked. This includes the usage of pharmaceuticals 30 and the usage of supplies 40. Services 55 may also be tracked.

In step 212, the data is sent to a database 50. This data is then stored for a predetermined amount of time. After a certain amount of time the information may automatically be transmitted to the server 10.

At step 214, the server 10 may access the database 50. The server 10 may request from the database 50 information related to the materials 15. This data may include the number of supplies 40 that are remaining.

At step 216, the server 10 will process the data in order to determine whether or not there is sufficient material 15. The step of processing may involve comparing the received data to data that had been previously sent, or comparing the received data to predetermined amounts of supplies that are necessary. Once the number of materials drop below a threshold level the need for reordering would occur. The server 10 may also analyze past data in order to compare what the past needs were in order to anticipate the future needs of an organization and pre-order materials before they are potentially depleted.

Furthermore, complex analysis may take place that fully analyzes usage patterns of the materials 15 in order to determine if there are specific scenarios that can reduce overall cost of ordering more supplies.

For example information received regarding the usage of the pharmaceuticals 30 may indicate that when certain pharmaceuticals 30 are out of supply, cheaper alternatives are used that are just as effective. This conclusion may be cross-referenced with patient data and recovery rates. This may prompt the server 10 to determine that a reduced number of the more costly pharmaceuticals 30 should be ordered and more of the lower cost pharmaceuticals 30 should be ordered, thereby prompting more usage of the generic. The periodic analysis of use patterns can help reduce the waste of materials by ordering only those materials that are needed, or should be needed.

The server 10 may also detect when usage patterns of a certain piece of the materials 15 has unusually spiked prompting an unusual increase in the need for ordering more of that item of the materials 15. In these scenarios, it may prove beneficial to fully analyze people data in order to determine if there is a direct correlation between the data from the people 45 and the data from the materials 15 and/or from the services 55. For example, whether or not there is a certain employee at an organization who is using an item of the materials 15 at a rate that is unusual may be determined from a full analysis of the history. It may also determine whether or not certain food items have been used at an increasing rate indicating possible theft.

At step 218 the server 10 makes the decision as to whether or not there is sufficient material 15. If there is sufficient material 15 then the server 10 will wait for a certain period of time before accessing the database 50, or receiving another update from the database 50. At that time another analysis will be performed. If there is not sufficient material 15 then the system will move onto the next step.

At step 220, a request may be sent to a supplier 60 for more material 15, when it has been determined that it is needed. The automatic contacting of the supplier 60 is an optional step that may be performed. The server 10 may also automatically search and analyze the costs from a number of suppliers 60. This may occur each time that the server 10 determines that there is a need for more material 15. By doing this, the client 20 may guarantee that the best deal is being obtained. The supplier 60 may then ship the item to the client 20. This method may be also applied to existing systems should it be desired.

It should be understood that in the method being discussed in FIG. 3 that the supplier 60 may be replaced by the provider of a service such as cleaning services, repair services, food services, etc. For example, database 50 may keep track of data related to equipment that is broken or in need of servicing. It may also keep track of remaining cleaning supplies in order to schedule more cleaning services. The ordering or rescheduling of services may automatically be performed.

Although, the server 10 is described above as being the component of the system that handles the computation and analysis of the data related to materials, services and people, it should be understood that analysis of the data can be accomplished on a computer system that is located locally to any organization. Data may be manually entered directly into the system and the analysis may be performed separate from the network system.

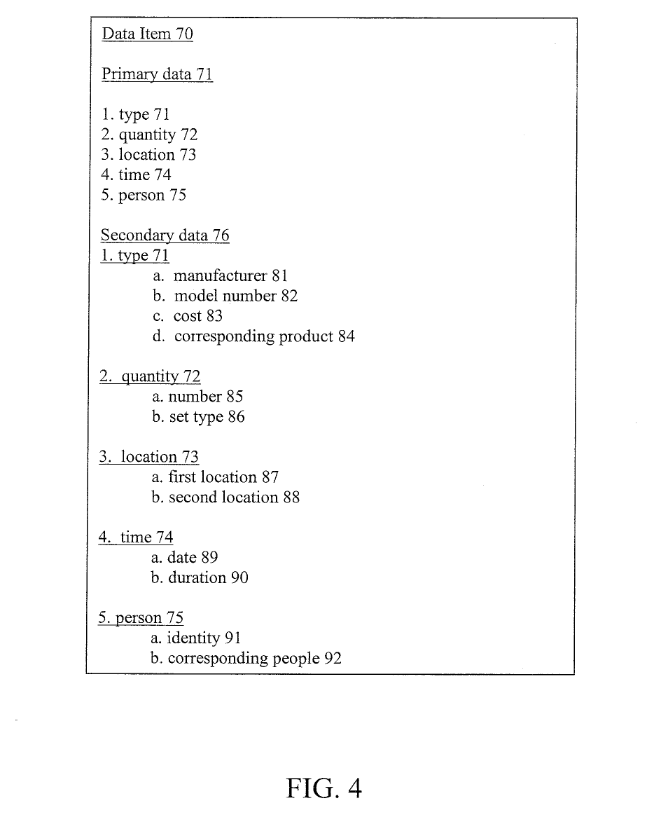

FIG. 4 illustrates a sample data item 70 that may be used in the system. The data item 70 may be a stored file on a computer system and be associated with the identifying element of the system. For example the data item 70 may be the file that is accessed when a specific bar code is scanned. The data item 70 may also be accessed when using any of the tracking and/or analyzing means discussed above. The data item 70 may comprise a number of factors that are used in order to facilitate the analysis of the usage of the material. When utilizing the analysis feature of the system it is important to provide those items that are to be tracked with tagged data so that meaningful comparisons can be made. As discussed above, the primary data 71 associated with a data item 70 are as follows: the type 71, the quantity 72, the location 73, the time 74 and the person 75. Other primary data items may be developed and used depending upon the needs of the organization.

Each of the primary data items 71 may have associated with them a number of secondary data items 76. Not all of the categories have to be filled, however the system may be designed to accommodate a wide variety of services and products that are used in an organization. Some of the categories may be variable data that is updated as the system is updated. Each data item 70 may have a history that is associated with it in order to keep track of how a specific item or product is used or accessed.

The secondary data 76 associated with each of the primary data items 71 may be specialized for each specific organization. The secondary data items 76 shown in FIG. 4 represent general categories that may be used and could be applicable to a variety of organizations. The type data item 71, has a number of correlating information that can be associated with it. The type data item 71 shown in FIG. 4 has manufacturer 81, model number 82, cost 83, and corresponding product data 84. The manufacturer data 81 may include information related to who makes the product. The model number data 82 may include information specifically related to that product in order to further identify. The cost data 83 may include recent information related to the cost of the product. This information may be updated periodically depending on changes in price and other information related to the cost. The corresponding product data 84 may include information related to the other products that this product is typically used with. For instance, if the product was laundry soap, it may include information related to the number of linens that it is being used in conjunction with it. If the product was surgical gauze it might include a variety of other medical equipment that it might be used with or associated procedures in which it used.

The quantity date 72 may include number data 85, which may include what number the product is of certain number of products, for example 3 of 15. This information may also include data related to how much of the product is left. The set type data 86 may include information related to how the product may be packaged. For instance it may be packaged individually or in various sets.

Location data 73 may include information related to where a product is being used or where a service may be performed. First location data 87 may include information related to a primary location that the product is at. The data related to the location may be tracked in real-time. In addition to the first location data 87 there may be second location data 88, as well as additional location data should the need arise. The second location data may include information related to additional areas in which the product may be used, or alternatively log the movement of a product from one location to another.

The time data 74 may include information related to the data 89 on which the product is used, or the service is performed. The duration data 90 may include information related to how long the product is used, or how long it takes to perform a certain service. This information may be tracked in real-time. This information may also be used in conjunction with the first location data 87 and the second location data 88 in order to track travel time. This information can help in finding more efficient locations to store items, or monitor the productivity of personnel assigned to transport or move material or equipment, etc.

The person data 75 may include information related to who is using a specific product. This information may include identity data 91 which may indicate who is using the product or alternatively who is authorized to be using the product. When tracking the information in the system, identity data 91 may be used in order to prevent misuse of products, such as pharmaceuticals, etc. The corresponding people data 92 may indicate which other people may be authorized to handle the information, or who may be using the product in association with the other individuals in the area.

Other types of information may be tracked and kept record of by the system and are not limited to the data classifications provided above. In the system disclosed above the information is kept in the database 50; however it is to be understood that this information may be kept in hardcopy form as well.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for tracking comprising:
a client for querying a server for data related to at least one of the categories selected from the group consisting of material, people and services;
a server for receiving queries from said client related to said at least one of the categories;
a database for receiving data, wherein said database stores data related to said at least one of the categories; and
wherein said server is further enabled to analyze said data in order to track usage of the at least one of said categories.

2. The system of claim 1, wherein said server automatically orders materials from a supplier.

3. The system of claim 1, wherein the server further is enabled to compare the data to other data in order to produce comparison data.

4. The system of claim 3, wherein the server is adapted to send comparison data to said client.

5. The system of claim 1, further comprising RFID devices attached to said at least one of the categories.

6. The system of claim 1, further comprising bar codes placed on said at least one the categories.

7. The system of claim 1, wherein the data tracked is selected from the group consisting of cost, manufacturer, material, and quantity.

8. The system of claim 1, wherein the data about said people is selected from the group consisting of identity, location of use, and quantity of use.

9. The system of claim 1, wherein the people are selected from a group consisting of physicians, patients, and hospital personnel.

10. The system of claim 1, wherein the server is adapted to compare the people data to past people data in order to produce comparison data.

11. A method of reducing costs in a system comprising the steps of:
gathering past data related to material and/or services used by an organization by accessing data about said material and/or services accumulated by the organization;
providing the data to a server;
processing the data at the server in order to analyze usage of said materials and/or services; and
transmitting the results of processing the data to a client; wherein the result comprise improvements to existing usage of materials and/or services.

12. The method of claim 11, further comprising creating metrics in order to analyze the data.

13. The method of claim 12, further comprising placing the past data into a database, wherein the past data is sent from the database to the server.

14. The method of claim 13, wherein the step of processing further comprises creating comparison data with other organizations.

15. The method of claim 11, wherein the past data selected from the group consisting of cost and quantity of a material.

16. The method of claim 11, wherein the past data gathered is selected from the group consisting of identity, location of use, and quantity of use by a person.

17. The method of claim 11, wherein the past data gathered is about hospital personnel and/or patients.

18. A method of using comparison metrics in a healthcare network comprising:
analyzing data kept by a healthcare organization;
establishing a first metric related to usage of material and/or services;
establishing a second metric related to usage of material and/or services;
establishing a third metric establishing a time frame;
combining said first metric, said second metric and said third metric in order to create a comparison unit;
using said comparison unit to compare said healthcare organization with other healthcare organizations;
providing means for improving said healthcare organization.

19. The method of claim 18, wherein cost data is attached to said first metric.

20. The method of claim 18, wherein the comparison unit is used in order to anticipate the needs of the healthcare organization.
